(19) United States
(12) Patent Application Publication
(10) Pub. No.: US 2015/0352847 A1
(43) Pub. Date: Dec. 10, 2015

(54) LIQUID EJECTING APPARATUS, CONTROL METHOD OF LIQUID EJECTING HEAD, AND CONTROL METHOD OF LIQUID EJECTING APPARATUS

(71) Applicant: Seiko Epson Corporation, Tokyo (JP)

(72) Inventors: Junhua ZHANG, Shiojiri-shi (JP); Miharu KANAYA, Azumino-shi (JP)

(21) Appl. No.: 14/733,675

(22) Filed: Jun. 8, 2015

(30) Foreign Application Priority Data
Jun. 9, 2014 (JP) 2014-118298

(51) Int. Cl. B41J 2/165

(52) U.S. Cl. CPC B41J 2/16535

(57) ABSTRACT

A flushing process is performed in which a nozzle surface of a recording head is wiped with a wiper and then an ejecting operation is performed by driving an actuator with a flushing pulse within 3.5 [s]. The flushing pulse in the flushing process is preferably a driving waveform which does not actively draw a meniscus in the nozzle toward a pressure chamber side, and makes the ink be ejected from the nozzle by extruding the meniscus toward an ejecting side.

### BACKGROUND

1. Technical Field

The present invention relates to a liquid ejecting apparatus such as an ink jet recording apparatus, a control method of a liquid ejecting head mounted on the liquid ejecting apparatus, and a control method of the liquid ejecting apparatus, and more particularly, to a liquid ejecting apparatus which performs a maintenance process to recover an ejecting ability of a liquid ejecting head, a control method of the liquid ejecting head, and a control method of the liquid ejecting apparatus.

2. Related Art

A liquid ejecting apparatus is a device which includes a liquid ejecting head and ejects (discharges) various liquids using the liquid ejecting head. As such a liquid ejecting apparatus, for example, there is an image recording apparatus such as an ink jet type printer or an ink jet type plotter; however, recently, various manufacturing apparatuses adopt a feature capable of making a small amount of the liquid accurately land to a predetermined position. For example, the liquid ejecting apparatus is used in a display manufacturing apparatus for manufacturing a color filter such as a liquid display, an electrode forming apparatus for forming an electrode such as an organic electro-luminescence (EL) display or a surface light emission display (FED), and a chip manufacturing apparatus for manufacturing a biochip (biochemical element). A recording head for an image recording apparatus ejects a liquid type ink, and a color material ejecting head for a display manufacturing apparatus ejects a solution of each color material of R (Red), G (Green), or B (Blue). In addition, an electrode material ejecting head for an electrode forming apparatus ejects a liquid type electrode material, and a biochemical organic substance ejecting head for a biochip manufacturing apparatus ejects a bio-organic substance solution.

Here, there is a case in which a bubble comes to be mixed in the liquid in a nozzle in the liquid ejecting head. Specifically, for example, there is a case in which when a surface of the nozzle (a nozzle surface) is wiped and becomes cleaned by sliding a wiping member (a wiper configured of an elastic member, or the like) with respect to the surface of the liquid ejecting head on which the nozzle is formed, the bubble enters into the liquid inside of the nozzle. In addition, there is also a case in which fine paper powder, which is generated from recording paper as a recording medium and attached to the nozzle surface, enters into the nozzle, and the bubble enters into the liquid in the nozzle through the paper powder. Further, there is also a case in which when a thickened liquid near the nozzle is ejected, the bubble enters into the liquid.

The liquid ejecting apparatus in which this kind of the liquid ejecting head is mounted performs a maintenance process, which is a so called flushing for forcedly ejecting the liquid from the nozzle, separately from an ejecting process of the liquid with respect to a landing object such as a recording medium for discharging the bubble or the thickened liquid in the nozzle or a pressure chamber of a liquid ejecting head, that is, an ejecting process which is a basic aim of the liquid ejecting apparatus (for example, refer to JP-A-2009-073076). The flushing process is performed to drive an actuator by applying a driving waveform to the actuator, and in the process, a pressure fluctuation is generated in the liquid in the pressure chamber communicating with the nozzle, and then the liquid is ejected (flushed or idle-discharged) from the nozzle using the pressure fluctuation. At this time, in general, first, a meniscus in the nozzle is drawn to the pressure chamber side by depressurizing the inside of the pressure chamber, then the meniscus is extruded toward a side (ejecting side) opposite to the pressure chamber side by rapidly depressurizing the inside of the pressure chamber so that liquid droplets are ejected from the nozzle. By continuously repeating such an operation at a predetermined number of times, the thickened liquid in the nozzle or the pressure chamber is discharged.

However, when the bubble is mixed in the liquid in the nozzle by wiping the nozzle surface, in the flushing process of the related art, since an ability of discharging the bubble in liquid in the nozzle is not sufficient, there is a problem in that the liquid is uneconomically consumed in the process. Particularly, when the bubble in the liquid in the nozzle is moved to the pressure chamber side, the bubble is more difficult to be discharged in the flushing process. In this case, the maintenance process (so called cleaning process) in which the liquid is sucked from the nozzle by negatively pressurizing the nozzle surface is required to be performed; however, in this process, there is a problem in that the liquid is consumed much more than the liquid used in the flushing process.

### SUMMARY

An advantage of some aspects of the invention is to provide a liquid ejecting apparatus capable of efficiently discharging a bubble in a nozzle while suppressing consumption of liquid, a control method of a liquid ejecting head, and a control method of the liquid ejecting apparatus.

According to an aspect of the invention, there is provided a liquid ejecting apparatus including a liquid ejecting head that includes a pressure chamber communicating with a nozzle and an actuator generating a pressure fluctuation in liquid in the pressure chamber, and is capable of ejecting the liquid from the nozzle by an operation of the actuator; and a wiper that wipes a nozzle surface of the liquid ejecting head on which the nozzle is formed, in which the liquid ejecting apparatus is able to perform a maintenance process by driving the actuator with a driving waveform, and the maintenance process is performed by driving the actuator with the driving waveform within 3.5 [s] after the nozzle surface is wiped by the wiper so as to perform an ejecting operation.

In this case, it is possible to efficiently discharge the bubble in the nozzle while suppressing uneconomical consumption of the liquid. That is, a maintenance process is performed within 3.5 [s] after a nozzle surface is wiped with a wiper, and then the bubble can be quickly discharged with the ink from the nozzle before the bubble mixed in the in the nozzle is floated to the pressure chamber side and goes away from the meniscus. Accordingly, consumption of the liquid can be significantly suppressed compared to the maintenance process of the related art.

In the printing apparatus, the driving waveform may be a driving waveform that does not actively draw a meniscus in the nozzle to the pressure chamber side from the initial position, and makes the liquid be ejected from the nozzle by extruding the meniscus toward an ejecting side.

In this case, the meniscus in the nozzle is not actively drawn from the initial position to the pressure chamber side, and the liquid is ejected from the nozzle by extruding the meniscus from the initial position so that the bubble near the meniscus being unnecessarily expended is suppressed. It is possible to efficiently discharge the bubble in the liquid in the nozzle with a small ejecting amount while suppressing floating the bubble to the pressure chamber.

In the printing apparatus, the driving waveform may be a driving waveform that changes the meniscus in the nozzle from the initial position to the pressure chamber side, and makes the liquid be ejected from the nozzle by extruding the meniscus toward an ejecting side.

In this case, a driving waveform used in the general maintenance process, or the like can be used.

According to another aspect of the invention, there is provided a control method of a liquid ejecting head which includes a pressure chamber communicating with a nozzle and an actuator generating a pressure fluctuation in liquid in the pressure chamber, and is capable of ejecting the liquid from the nozzle by an operation of the actuator, the method including performing a maintenance process by driving the actuator with the driving waveform within 3.5 [s] after wiping a nozzle surface by a wiper so as to perform an ejecting operation.

According to still another aspect of the invention, there is provided a control method of a liquid ejecting apparatus which includes a liquid ejecting head that includes a pressure chamber communicating with a nozzle and an actuator generating a pressure fluctuation in liquid in the pressure chamber, and is capable of ejecting the liquid from the nozzle by an operation of the actuator, and a wiper that wipes a nozzle surface on which the nozzle of the liquid ejecting head is formed and is able to perform a maintenance process by driving the actuator with a driving waveform, the method including performing the maintenance process by driving the actuator with the driving waveform within 3.5 [s] after wiping the nozzle surface by the wiper so as to perform an ejecting operation.

### BRIEF DESCRIPTION OF THE DRAWINGS

The invention will be described with reference to the accompanying drawings, wherein like numbers reference like elements.

FIG. 1 is a front view describing an internal configuration of a printer.

FIG. 2 is a block diagram describing an electrical configuration of the printer.

FIG. 3 is a cross-sectional view describing an internal configuration of a recording head.

FIG. 4 is a flow chart describing a flow of control of the printer.

FIGS. 5A and 5B are schematic diagrams describing a wiping process and a flushing process.

FIG. 6 is a waveform chart describing a configuration of a driving signal used in the flushing process.

FIG. 7 is a waveform chart describing a configuration of a flushing pulse.

FIG. 8 is a waveform chart describing a configuration of a flushing pulse of the related art.

FIGS. 9A to 9C are schematic diagrams describing a state in which the ink is ejected from a nozzle in the flushing process.

### DESCRIPTION OF EXEMPLARY EMBODIMENTS

Hereinafter, embodiments of the invention will be described with reference to attached drawings. In the embodiments as follows, each of the embodiments are limited as appropriate examples of the invention; however, a range of the invention is not limited to a description as long as the description which is limited to the invention is not disclosed in the description hereinafter. In addition, hereinafter, as a liquid ejecting apparatus of the invention, an ink jet recording apparatus (hereinafter, referred to as a printer) is described as an example.

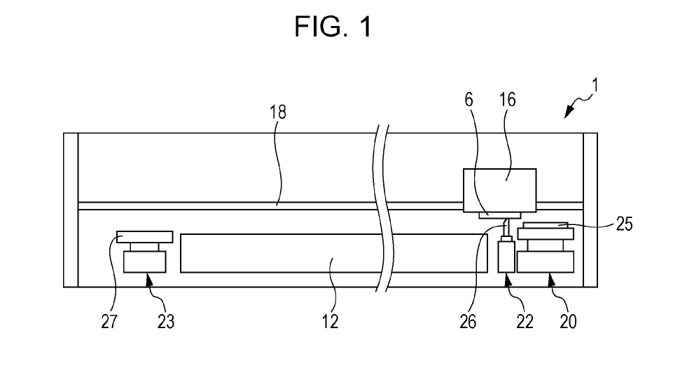

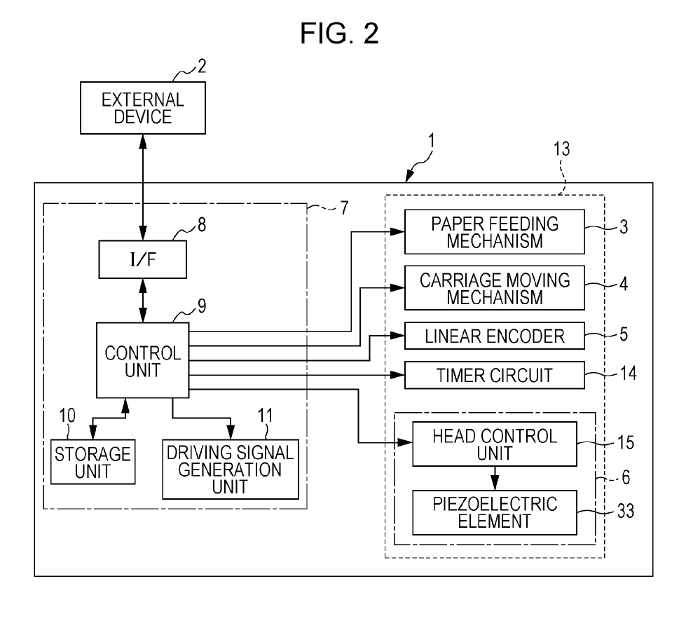

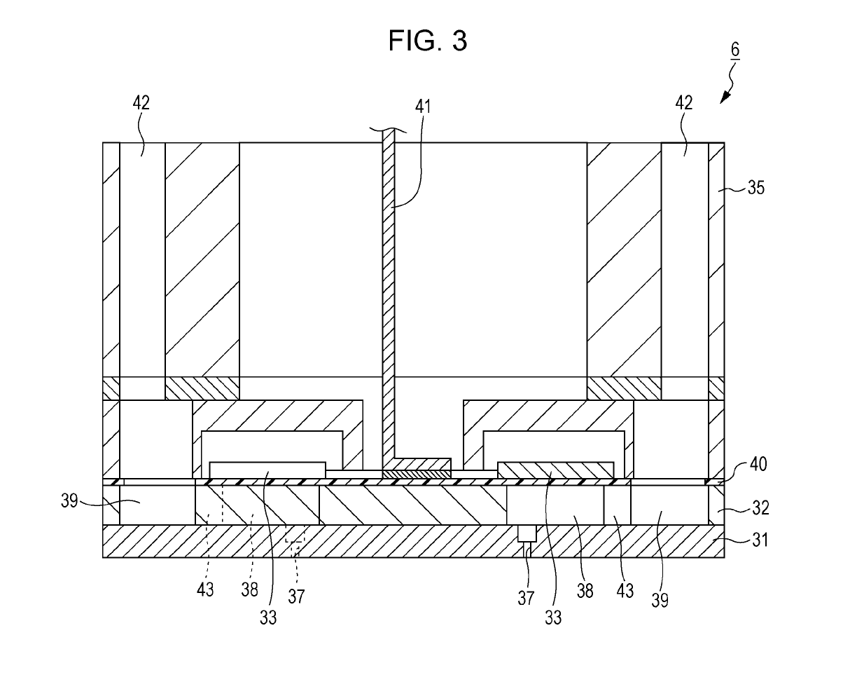

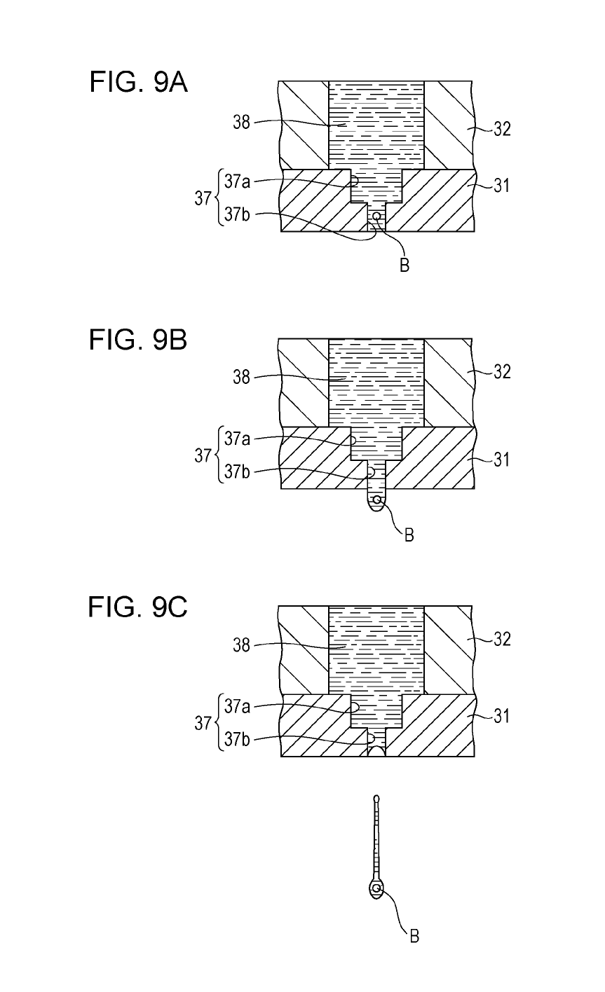

FIG. 1 is a front view describing an internal configuration of a printer 1, and FIG. 2 is a block diagram describing an electrical configuration of the printer 1. The printer 1 in the embodiment is electrically connected to, for example, an external device 2 of an electronic device such as a computer in a wired or wireless state and receives printing data according to an image, or the like, for printing the image or a text to a recording medium (landing object of liquid) such as recording paper from the external device 2. The printer 1 includes a printer controller 7 and a printer engine 13. A recording head 6 as a type of the liquid ejecting head is installed on a bottom surface side of a carriage 16 in which an ink cartridge 17 (liquid supplying source) is mounted. The carriage 16 is configured to be capable of being reciprocated along a guide rod 18 by a carriage moving mechanism 4. That is, the printer 1 sequentially transports the recording medium onto a platen 12 by a paper feeding mechanism 3 and relatively moves the recording head 6 in a width direction (main scanning direction) of the recording medium so that the image, or the like is recorded by ejecting the ink of a liquid type in the invention from a nozzle 37 of the recording head 6 (refer to FIG. 3 and FIGS. 9A to 9C) the recording medium and making the ink land onto the recording medium. In addition, the invention can adopt a configuration in which the ink cartridge 17 is disposed in a main body side of the printer, and the ink in the ink cartridge 17 is transferred to the recording head 6 side through a supply tube.

As the ink described above, various inks such as a dye ink, a pigment ink can be used. In the embodiment, the ink having a viscosity η1 of 4.12 [mPa·s] degree at room temperature (for example, 25° C.) is used. In addition, the ink having a viscosity η2 of 5.0 [mPa·s] degree at room temperature (for example, 25° C.) can be also used. According to a density thereof, it is preferably in a range of 1050 [g/cm³] or more to 1100 [g/cm³] or less, and according to a viscosity thereof, it is appropriately within a range of 3 [mPa·s] or more to 6 [mPa·s] or less.

A home position as a standby position of the recording head 6 is set at a position deviated from one end side of the main scanning direction with respect to a platen 12 (right side in FIG. 1). In the home position, a capping mechanism 20 and a wiping mechanism 22 are installed sequentially from one end side. In addition, a flushing box 23 as a flushing region is installed in the other end portion (left side in FIG. 1) of the main scanning direction in which the platen 12 is sandwiched between the home position and the other end portion. The capping mechanism 20 includes, for example, the cap 25 constituted of an elastic member such as an elastomer, and is configured to be capable of being switched between a state (capping state) in which the cap 25 is brought into contact with a nozzle surface (nozzle plate 31) of the recording head 6 and sealed, and an escape state in which the cap 25 is separated from the nozzle surface. By negatively pressurizing (suction) the inside of the cap with respect to the nozzle surface in the capping state, a cleaning process in which the ink from the nozzle is discharged into the cap can be performed. In addition, the cap 25 also functions as an ink receiving portion that receives the ejected ink at the time of performing the flushing process.

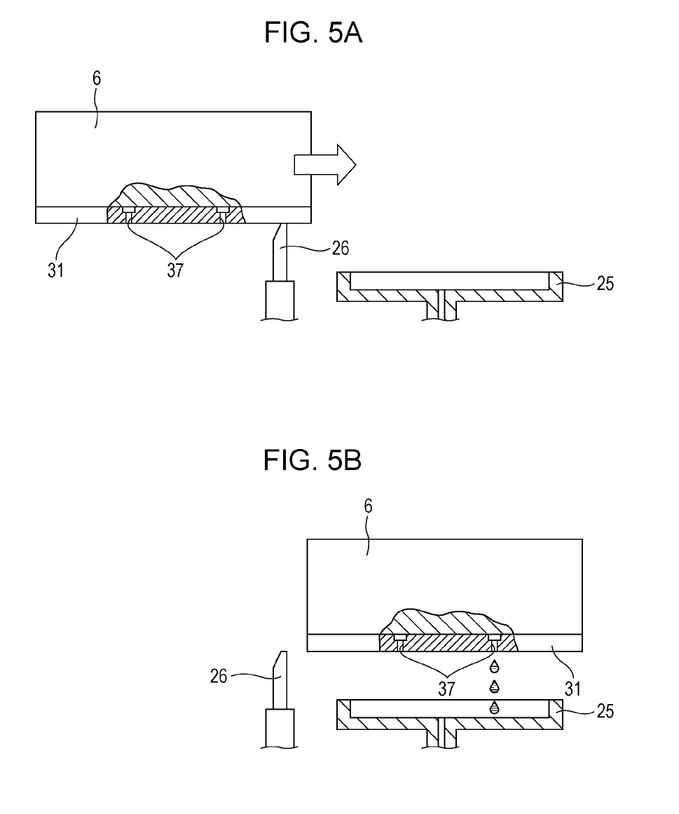

The wiping mechanism 22 wipes the nozzle surface of the recording head 6 by the wiper 26, and is configured to be capable of being switched between a state in which the wiper 26 is brought into contact with the nozzle surface and an escape state in which the cap 25 is separated from the nozzle surface. The wiper 26 can adopt various configurations; however, for example, it is configured to have a blade main body having an elasticity of which a surface is covered with fabrics. According to the embodiment, in the state in which the wiper 26 is brought into contact with the nozzle surface, by moving the recording head 6 in the main scanning direction, the wiper 26 slides and wipes the nozzle surface (refer to FIGS. 5A and 5B). Moreover, a configuration in which the wiper 26 wipes the nozzle surface by automatically moving in a state in which the recording head 6 stops moving can be adopted. In short, it is preferable that a configuration in which the nozzle surface is wiped by relatively moving the recording head 6 and the wiper 26 is adopted. The above described flushing box 23, regardless of a recording process with respect to the recording medium, includes an ink receiving portion 27 in a tray shape that receives the ejected ink at the time of the flushing process by forcedly ejecting the ink from the nozzle of the recording head 6. A position of the ink receiving portion 27 is fixed.

The printer controller 7 is a control unit that controls each of the units of the printer. The printer controller 7 in the embodiment includes an interface (I/F) unit 8, a control unit 9, a storage unit 10, and a driving signal generation unit 11. The interface unit 8 transmits printing data or printing instructions from an external device 2 to the printer 1 or performs receiving and transmitting of state data of the printer at the time of outputting information of a state of the printer 1 to the external device 2 side. The control unit 9 is a calculation processing device for controlling the entirety of the printer. The storage unit 10 is an element storing data used in a program or various controls of the control unit 9 and includes a ROM, a RAM, and a NVRAM (non-volatile storage element). The control unit 9 controls each of the units according to a program stored in the storage unit 10. In addition, the control unit 9 in the embodiment, based on the printing data from the external device 2, generates ejecting data which indicates which nozzle 37 ejects the ink at which timing at the time of a recording process, and transmits the generated ejecting data to a head control unit 15 of the recording head 6. Further, the control unit 9 in the embodiment functions as a control unit that performs the flushing process which is a type of the maintenance process. A detailed description thereof will be described later.

The driving signal generation unit 11 (driving waveform generating unit) generates a driving signal including a driving pulse for recording an image, or the like by ejecting the ink to the recording medium. In addition, the driving signal generation unit 11 in the embodiment is configured to be capable of generating the driving signal for maintenance (driving signal COM for flushing) including a maintenance driving waveform (flushing pulse Pf). A detailed description of the driving signal for flushing will be described later.

Next, the printer engine 13 will be described. The printer engine 13 includes, as illustrated in FIG. 2, a paper feeding mechanism 3, a carriage moving mechanism 4, a linear encoder 5, a timer circuit 14, and a recording head 6. The carriage moving mechanism 4 is configured to have a carriage 16 in which the recording head 6 is installed, a driving motor (for example, a DC motor) driving the carriage 16 through a timing belt, or the like (not illustrated), and moves the recording head 6 installed in the carriage 16 in the main scanning direction. The paper feeding mechanism 3 is configured to have a paper feeding motor, a paper feeding roller, and the like (neither of them are illustrated), and performs sub-scanning by sequentially feeding the recording medium onto the platen 12. In addition, the linear encoder 5 outputs an encoder pulse, according to a scan position of the recording head 6 installed in the carriage 16, to the printer controller 7 as position information in the main scanning direction. The printer controller 7 can control the scan position (current position) of the recording head 6 based on the encoder pulse received from the linear encoder 5 side. The timer circuit 14 in the embodiment is used for regulating a timing of the flushing process performed after the wiping process. A detailed description thereof will be described later.

FIG. 3 is a main part cross-sectional view describing an internal configuration of the recording head 6. The recording head 6 in the embodiment is schematically configured to have a nozzle plate 31, a flow path substrate 32, a piezoelectric element 33, and the like, and is installed in a case 35 in a state of multi-layered members. The nozzle plate 31 is a member constituted of a silicon single crystal substrate in which a plurality of the nozzles 37 is formed to be arranged in a line along the same direction at a pitch in response to a dot forming density. In the embodiment, a nozzle row (a shape of the nozzle group) configured to have a plurality of the nozzles 37 arranged in parallel is arranged in two rows on the nozzle plate 31 in parallel. In addition, a surface of the nozzle plate 31 on a side on which the ink is ejected is brought into contact with the nozzle surface.

The above described nozzle 37 is formed in a cylindrical shape of plurality of stages having different inner diameters by dry etching. The nozzle 37 in the embodiment is formed in a two-stages structure made by a first nozzle portion 37a of a pressure chamber 38 side and a second nozzle portion 37b of an ejecting side (refer to FIGS. 9A and 9B). In addition, an inner diameter of the first nozzle portion 37a is set to be larger than an inner diameter of the second nozzle portion 37b. More specifically, the inner diameter of the second nozzle portion 37b is 20 [m], and the inner diameter of the first nozzle portion 37a is 45 [m]. A length of the second nozzle portion 37b in the central axis direction is 30 [m], and a length of the first nozzle portion 37a in the central axis direction is 40 [m]. Moreover, the nozzle plate 31 is not limited to the silicon single crystal substrate, and for example, can also be formed of a metal plate such as stainless steel. In addition, it is preferable that the nozzle 37 includes the straight part having a constant inner diameter in a cylindrical shape at least on the ejecting side, and the nozzle 37 adopts a configuration in which the inner diameter of the entire nozzle has a constant inner diameter (nozzle in a cylindrical shape), or a configuration in a taper shape in which the inner diameter corresponding to the first nozzle portion 37a is enlarged toward the pressure chamber side from the ejecting side.

On the flow path substrate 32, the pressure chamber 38 is formed in plural, which is divided by a plurality of partition walls, corresponding to the nozzle 37. In the outside of a row of the pressure chamber 38 in the flow path substrate 32, a common liquid chamber 39 that divides a part of the common liquid chamber 39 is formed. The common liquid chamber 39 individually communicates with the pressure chamber 38 through an ink supply inlet 43. In addition, the ink from the ink cartridge 17 side is introduced to the common liquid chamber 39 through an ink introduction path 42 of the case 35. In an upper surface opposite to the nozzle plate 31 side of the flow path substrate 32, the piezoelectric element 33 (a type of an actuator) is formed on an elastic film 40. The piezoelectric element 33 is formed by a configuration in which a lower electrode film made of metal, a piezoelectric layer made of for example, lead zirconate titanate, and an upper electrode film made of metal (none of them are illustrated) are sequentially layered. The piezoelectric element 33 is a so called piezoelectric element in a deflection mode and is formed to cover an upper portion of the pressure chamber 38. In the embodiment, a piezoelectric element row in two rows corresponding to a nozzle row in two rows is parallel to a direction orthogonal to the nozzle row in a state in which the piezoelectric elements 33 are alternately disposed when viewed from a nozzle row direction. Each piezoelectric element 33 is deformed by being applied with the driving signal through a wiring member 41. Accordingly, the pressure fluctuation is generated in the ink in the pressure chamber 38 corresponding to the piezoelectric element 33, and the ink is ejected from the nozzle 37 by controlling the pressure fluctuation of the ink.

The printer 1 according to the invention has a feature in which the flushing process is performed. The flushing process is aimed to remove the bubble in the nozzle 37 by wiping the nozzle surface (nozzle plate 31) of the recording head 6 using the wiping mechanism 22 at a time when a certain time elapses. A detailed description thereof will be described.

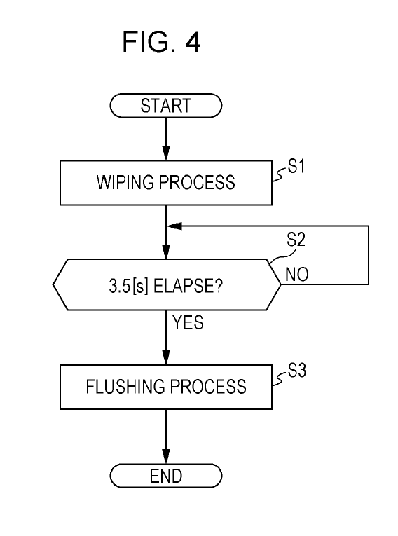

FIG. 4 is a flow chart describing a flow of a control of the above described printer 1. In addition, FIGS. 5A and 5B are respectively schematic diagrams describing a wiping process and a flushing process.

The wiping process in Step 51, the recording head 6 is moved to an upper side of the wiping mechanism 22 of the home position, and the recording head 6 is moved to the capping mechanism 20 side in a state in which a fore-end portion of the wiper 26 is brought into contact with the nozzle surface (a surface of a side to which the ink of the nozzle plate 31 is ejected) of the recording head 6 (FIG. 5A). Accordingly, the wiper 26 is relatively moved from one side to the other side in the main scanning direction of the nozzle surface so that the nozzle surface is wiped. There is a case in which the bubble is mixed into the nozzle 37 by the wiping process. Specifically, when the wiper 26 passes an opening edge of the nozzle 37, the bubble is mixed in the ink in the nozzle 37 with the ink attached to the wiper 26. For this reason, the bubble mixed in the ink in the nozzle 37 is discharged by continuously performing the flushing process after the wiping process.

The bubble mixed in the ink in the nozzle 37 is moved to the pressure chamber 38 side by buoyancy as time elapses. When the bubble falls from the meniscus in the nozzle 37 to the pressure chamber 38 side, there is a concern that an ability of discharging the bubble in the flushing process deteriorates. For example, when the bubble is positioned on the pressure chamber side in a range of 35 [μm] from the meniscus in the central axis direction of the nozzle 37 (from the ejecting side opening of the nozzle portion 37b), the bubble can be discharged by the flushing process. However, when the bubble is moved away exceeding the range of 35 [μm] from the meniscus in the central axis direction of the nozzle 37, the bubble is not easy to be discharged by even the flushing process. Here, the buoyancy applied to the bubble in the nozzle is indicated by a following equation (1) by the Archimedes Theorem, as the diameter of a bubble is r, the density of the ink is p, and gravity acceleration is g.

F=4πr³ρg/3 (1)

Next, the resistance force applied to the bubble is indicated by following Equation (2), as the density of the ink is η, a speed of the bubble (speed (infinite speed in liquid) in a case in which the flow path resistance is ignored by an inner wall of the nozzle) is U.

F=6πηrV (2)

The floating speed U of the bubble in the ink is indicated by following Equation (3) by Equation (1) and Equation (2).

U=4.5r²ρg/η (3)

Moreover, the floating speed u of the bubble in the nozzle 37 can be indicated by following Equation (4) proposed by Clift et al. or Equation (5) proposed by Wallis, as the inner diameter of the nozzle 37 is d and λ=r/d.

u/U=(1−λX²)^{3/2} for λ<0.6 (4)

u/U=1.13 exp(−λ) for λ<0.6 (5)

For example, when d=20 [μm], and r=10 [μm], ζ=0.5, and the floating speed u of the bubble in the second nozzle portion 37b becomes

u=0.650×U=9.42 [μm/s] by Equation (4)

u=0.685×U=9.94 [μm/s] by Equation (5).

Then, as the floating speed u of the bubble in the nozzle portion 37b is 9.94 [μm/s], a time taken when the bubble is moved from the meniscus (opening of the ejecting side of the nozzle portion 37b) to a position of 35 [μm] in a vertical direction can be calculated as 35/9.94≅3.5 [s]. In the embodiment, since a length of the central axis direction of the second nozzle portion 37b is 30 [μm], when the bubble is floated from the meniscus exceeding 30 um in the vertical direction, the inner diameter of the nozzle reaching the first nozzle portion 37a is changed and technically, the floating speed u of the bubble is also changed; however, a speed change in a range from more than 30 [μm] to 35 [μm] can be substantially ignored.

As described as above, considering that the bubble near the meniscus is floated to the pressure chamber side as time elapses, it is preferable that the flushing process is performed within 3.5 [s] after the nozzle surface is wiped by the wiper 26. Meanwhile, even though when the flushing process is performed in a unstable state, such as a state in which the bubble is attached to the meniscus of the nozzle 37 right after the flushing process is performed, the ink is not only normally ejected but also there is a possibility that much bubbles are possible to enter into the meniscus. For this reason, after the nozzle surface is wiped by the wiper 26, a time when the meniscus in the nozzle 37 becomes stable (for example, 1 [s]) within 3.5 [s] is preferably added.

In the embodiment, the control unit 9 monitors the timer circuit 14, and an elapsed time after the nozzle surface is wiped by the wiper 26 is calculated. Specifically, in each nozzle row, a time during the wiper 26 passes the nozzle row (an opening edge in front of the wiper wiping direction of the nozzle 37 belongs to the nozzle row) is calculated. The timing when the wiper 26 passes a predetermined nozzle 37 is controlled on the basis of an encoder pulse from the linear encoder 5. An elapsed time of the timer circuit 41 according to the timing when the wiper passes is monitored, in the embodiment, whether or not the elapsed time after the wiper 26 passes the nozzle row is 3.5 [s] is determined (Step S2). In addition, the determined time is not limited to 3.5 [s], and is preferable within 3.5 [s]. When it is determined that 3.5 [s] does not elapse after the wiper 26 passes the nozzle row (No), a process of Step S2 is repeated until 3.5 [s] elapses while the timer circuit 14 is monitored. Meanwhile, when it is determined that 3.5 [s] elapses after the wiper 26 passes the nozzle row (Yes), the control unit 9 controls the carriage moving mechanism 4, as illustrated in FIG. 5B, the carriage 16 is moved to an upper side of the capping mechanism 20, and the nozzle surface of the recording head 6 faces the cap 25 (refer to FIG. 1). In this state, the flushing process is performed in an order from the nozzle 37 (nozzle row) when 3.5 [s] elapses after the wiper 26 passes (Step S3). Moreover, if the flushing process can be performed within 3.5 [s] after the wiping process, the flushing process can be also performed on the carriage 16 with respect to the ink receiving portion 27 of the flushing box 23.

The flushing process in the embodiment is the maintenance process which aims to discharge the bubble mainly existing inside of the nozzle 37 (near meniscus) by performing an operation of the ink ejected from the nozzle 37, and it is different from a flushing process for discharging the thickened ink or the bubble in the nozzle 37 or in the pressure chamber 38 before the recording process by inputting power to the printer 1. Here, the ejecting operation in the flushing process means, regardless of whether or not the ink is actually ejected from the nozzle 37, an operation of the piezoelectric element 33 that generates the pressure fluctuation in the pressure chamber 38 by driving the piezoelectric element 33 with a flushing pulse Pf described later.

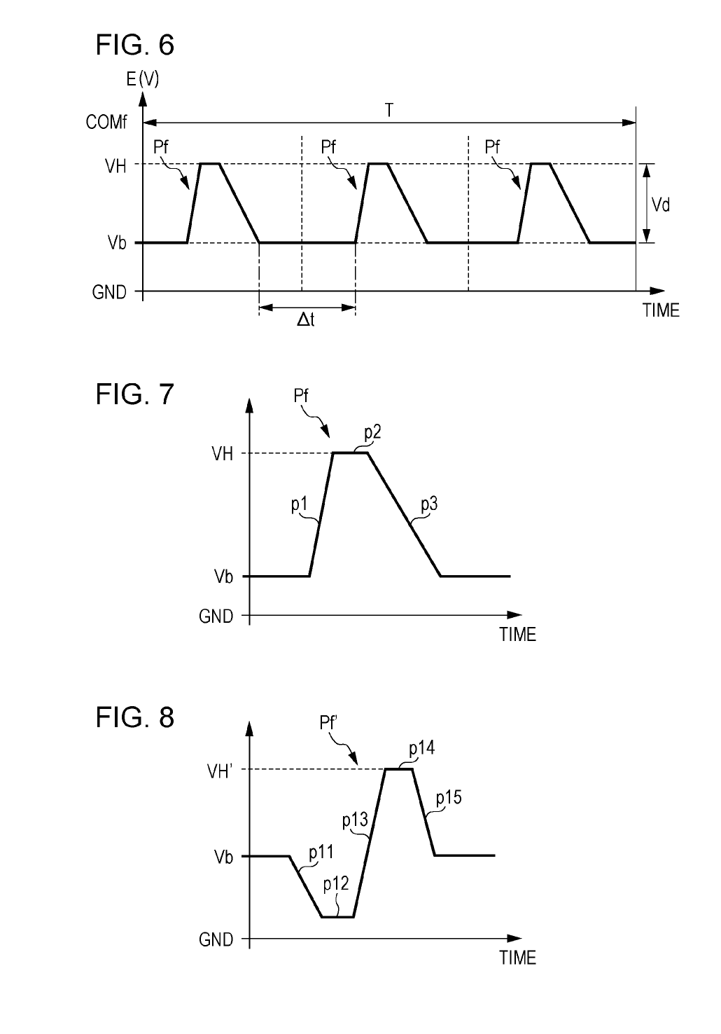

FIG. 6 is a waveform diagram describing an example of the driving signal for flushing used in the flushing process in Step S3. In addition, FIG. 7 is a waveform diagram describing a configuration of the flushing pulse Pf. The driving signal COMf for flushing in the embodiment generates the three flushing pulses Pf which are generated at constant intervals. The flushing pulse Pf is a type of the driving waveform (meniscus driving waveform) which ejects the ink by being pressed to the ejecting side without actively drawing the meniscus in the nozzle 37 from an initial position to the pressure chamber 38 side. More specifically, the flushing pulse Pf in the embodiment is constituted by a contraction element p1, a contraction maintenance element p2, and an expansion element p3. The contraction element p1 is a waveform element in which a potential from a reference potential Vb to a contraction potential VH is changed with a rapid gradient in a plus side. Here, a state in which the reference potential Vb is applied to the piezoelectric element 33 is an initial state (reference state), and a position of the meniscus in the nozzle 37 in the initial state corresponds to the initial position of the invention. A potential difference Vd from the reference potential Vb to the contraction potential VH and a gradient of a potential change of the contraction element p1 are set so that the maximum amount of the ink able to be ejected by the recording head 6 of the above configuration can be ejected from the nozzle 37. The contraction maintenance element p2 is a waveform element in which the contraction potential VH is maintained at a predetermined time. In addition, the expansion element p3 is a waveform element in which a potential from the contraction potential VH to the reference potential Vb is changed with a sufficient gentle gradient. Moreover, meaning that the meniscus is not actively drawn toward the pressure chamber side, basically, there is no waveform element in which the pressure chamber 38 is expanded so as to draw the meniscus toward the pressure chamber side before the contraction element p1 in the flushing pulse Pf. However, even though there are other waveform elements like the above before the contraction element p1, but if the waveform element is not easy to badly influence on the ability of discharging the bubble (for example, waveform element in which an initial potential of the contraction element p1 is adjusted to a potential different from the reference potential Vb, or the like), it is preferable that such a waveform element exists before the contraction element p1.

FIGS. 9A to 9C are respectively schematic diagrams describing a state in which the ink is ejected from the nozzle 37 in the flushing process (cross-sectional view of nozzle 37). FIG. 9A illustrates the initial state described above. The flushing process in the embodiment is performed at a time after the wiper 26 passes the nozzle 37 and 3.5 [s] elapses. At this time, the bubble B remains in the ink inside of the second nozzle portion 37b in the nozzle 37. When the flushing pulse Pf configured as described above is applied to the piezoelectric element 33 corresponding to the nozzle 37, the piezoelectric element 33 is bent toward the inside (side near the nozzle plate 31) of the pressure chamber 38 by the contraction element p1. Consequently, the pressure chamber 38 is rapidly contracted from a reference volume corresponding to the reference potential Vb to a contraction volume corresponding to the contraction potential VH. Accordingly, the ink in the pressure chamber 38 is put under pressure so that the meniscus in the initial position is rapidly pressed to the ejecting side along the nozzle in the central axis direction and is extended like a liquid column (FIG. 9B). At this time, the bubble B near the meniscus follows the ink in the nozzle and is pressed to the ejecting side. In addition, the bubble B is contracted according to a rise of a pressure in the pressure chamber 38.

The contraction state in the pressure chamber 38 is maintained at the predetermined time by the contraction maintenance element p2. During the time, a rear end portion of the liquid column pressed to the ejecting side is separated from the meniscus and rises toward the ink receiving portion 27 of the flushing box 23 in a state including the bubble B (FIG. 9C). After the contraction maintenance element p2, the expansion element p3 is sequentially applied, and then the piezoelectric element 33 is contracted until a state thereof corresponding to the reference potential Vb. Consequently, the pressure chamber 38 is gently expended from the contraction volume to the reference volume corresponding to the reference potential Vb and restored. Accordingly, the meniscus is gradually restored to the initial position. A weight per one drop of the ink ejected from the nozzle 37 by the flushing pulse Pf is approximately 10 [ng]. With respect to this, the weight per one drop of the ink ejected from the nozzle 37 when an image, or the like is recorded on the recording medium, is approximately 7 [ng]. In the flushing pulse Pf, since the change of the potential in the expansion element p3 is gentle compared to the contraction element p1, a pressure change generated in the pressure chamber 38 by driving the piezoelectric element 33 with the expansion element p3 is also relatively gentle. For this reason, a residual vibration after the ejecting operation is also suppressed to be relatively low.

In the embodiment, in the flushing process performed once, the flushing pulse Pf is applied three times to the piezoelectric element 33 corresponding to one of the nozzles 37 at constant intervals so as to perform the ejecting operation. An apply interval of the flushing pulse Pf at this time is set to be a degree of the time in which the residual vibration generated in the ink in the pressure chamber 38 and the nozzle 37 is substantially diminished before a next ejecting operation is performed by a previous ejecting operation. Accordingly, the ability of discharging the bubble B near the meniscus in the flushing process becomes high. That is, when the next ejecting operation is performed in a state in which the residual vibration generated by the previous ejecting operation is not diminished, there is a case in which the residual vibration exists. In addition, when the residual vibration becomes large, according to this, a degree of contraction or expansion of the bubble B in the nozzle 37 also becomes large. Here, by the above described Equation (3), since a moving speed to the pressure chamber side becomes fast as long as the bubble B is large, there is a concern that the ability of discharging the bubble in the flushing process deteriorates. Accordingly, in the flushing process, it is important that the bubble B is not expended as possible. That is, a change of an inner pressure of the pressure chamber 38, particularly, a rapid decompression is avoided, and it is preferable that the residual vibration causing a size of the bubble B to become large is suppressed as possible.

In the embodiment, the flushing pulse Pf ejecting the ink without actively drawing the meniscus in the nozzle 37 from the initial position (piezoelectric element 33) to the pressure chamber 38 side is adopted as a driving waveform for the flushing process, since the ink ejected from the nozzle 37 by pressing the ink from the initial position while suppressing stirring of the ink, the bubble B near the meniscus being unnecessarily expended is suppressed. Accordingly, the bubble B can be sufficiently discharged with a smaller ejecting amount while the bubble B is floated to the pressure chamber side. In addition, a time Δt from a final end of the previous flushing pulse Pf (final end of expansion element p3) to an initial end of the next flushing pulse Pf (initial end of contraction element p1) is set to be equal to or higher than a Helmholtz vibration cycle Tc (natural vibration frequency) of the vibration (pressure wave) generated in the ink in the pressure chamber 38. Accordingly, the next ejecting operation is performed in a state in which the residual vibration generated by the previous ejecting operation is substantially diminished, the unnecessary contraction or expansion of the bubble B decreases. For this reason, the bubble B moved to the pressure chamber 38 side by the buoyancy is suppressed; the ability of discharging the bubble can be improved. In addition, the ejecting operation is performed three times in the flushing process once at the above described interval, and the bubble in the nozzle 37 can be substantially discharged. For example, the ink is pressed to the ejecting side by a first ejecting operation even though the bubble is attached on the inner wall of the nozzle 37 and the ink is not ejected from the nozzle 37 by the first ejecting operation, and the bubble is easily deviated and moved from the inner wall of nozzle by moving the ink so that the bubble B with the ink can be discharged from the nozzle 37 by a second and a third ejecting operations. Moreover, in order to sufficiently discharge the bubble in the ink in the nozzle 37, it is preferable that the ejecting operation is performed three times by the flushing pulse Pf like the embodiment; however, for example, a configuration can be adopted in which at least the initial ejecting operation in three times of the ejecting operation is performed by the flushing pulse Pf, and remaining operations are performed by the other driving pulses, specifically, a general flushing pulse Pf or a driving pulse used in a typical recording operation. In addition, if the bubble B can be discharged, the ejecting operation is not limited to three times in the flushing operation but can be performed four times or more. In this case, the driving pulse after four times may be the flushing pulse Pf, or the other driving pulses.

Moreover, the above described Tc is set to be inherent in each recording head according to a shape, a size, and a rigidity of a configuration member such as the nozzle 37, the pressure chamber 38, an ink supply inlet 43, or the piezoelectric element 33. The natural vibration frequency Tc, for example, can be indicated by the next Equation (1).

Tc=2π√[[(Mn×Ms)/(Mn+Ms)]×Cc] (6)

In Equation (4), Mn indicates an inertance of the nozzle 37, Ms indicates an inertance of the ink supply inlet 43, and Cc indicates a compliance of the pressure chamber 38 (indicates change of volume per unit pressure and a softness degree). In addition, in Equation (6), the inertance M indicates an easiness of moving the liquid in a flow path, in other words, is a weight of the liquid per a unit cross-section area. Also, when the density of the fluid is p, the cross-section area orthogonal to a flow down direction of the fluid in the flow path is S, and a length of the flow path is L, the inertance M can be similarly indicated by Equation (7).

M=(Σ×L)/S (7)

Moreover, the above described Tc is not limited to a case regulated in Equation (6), but may be the vibration frequency included in the pressure chamber 38 of the recording head 6.

With respect to the flushing pulse Pf used in the flushing process, in the embodiment, the driving waveform ejecting the ink without actively drawing in the pressure chamber 38 side is exemplified; however, it is not limited thereto, but also a driving waveform generally used in the flushing process or the recording process can be used as the flushing pulse.

FIG. 8 is a waveform describing a modification example of the flushing pulse. The flushing pulse Pf in the modification example is constituted by a preliminary expansion element p11, an expansion maintenance element p12, a contraction element p13, a contraction maintenance element p14, and an expansion element p15. That is, the flushing pulse Pf makes the pressure chamber 38 expand by the preliminary expansion element p11 before the ink is ejected from the nozzle 37 so that the meniscus is drawn to the pressure chamber side in large. In the flushing pulse Pf, since the bubble is easily moved to the pressure chamber side by drawing the initial meniscus, the ability of discharging the bubble deteriorates compared to the flushing pulse Pf; however, for example, when the time after the wiper 26 passes the nozzle 37 until the flushing process is performed is set to be faster than 3.5 [s], the bubble with the ink in the nozzle 37 can be discharged by the flushing pulse Pf. In addition, since a driving waveform used in a general flushing process or a recording process can be used as the flushing pulse, it is convenient in that a separate flushing pulse does not need to be installed.

In the printer 1 according to the invention as described above, since the flushing process is performed within 3.5 [s] after the nozzle surface is wiped by the wiper 26, the bubble B with the ink from the nozzle 37 can be quickly discharged before the bubble B mixed in the ink in the nozzle 37 is floated fast to the pressure chamber 38 side and away from the meniscus. Accordingly, consumption of the ink can be significantly suppressed compared to the maintenance process such as the flushing process or the cleaning process by sucking in the related art.

Moreover, in the above described embodiment, as the actuator, the piezoelectric element 33 of a so called bending vibration type is exemplified, but it is not limited thereto, for example, a piezoelectric element of a so called longitudinal vibration type can be also adopted. In this case, the flushing pulse Pf which is exemplified in the above described embodiment is a waveform in a direction of changing a potential, that is, which is vertically inverted.

In addition, the actuator is not limited to the piezoelectric element, and various actuators such as an electrostatic actuator changing a volume of the pressure chamber using an electrostatic force can be adopted.

As long as the invention is the liquid ejecting apparatus that performs the flushing process in which the bubble in the nozzle is discharged, it is not limited to a printer, but can be adopted to various ink jet recording apparatuses such as a plotter, a facsimile apparatus, or a copy machine, a printing apparatus making an ink from the liquid ejecting head to be landed on a fabric (material to be printed) which is a type of an ink landing object, a liquid ejecting apparatus such as a display manufacturing apparatus, an electrode manufacturing apparatus, or a chip manufacturing apparatus, in addition to a recording apparatus, or the like.

What is claimed is:

1. A liquid ejecting apparatus comprising:
a liquid ejecting head that includes a pressure chamber communicating with a nozzle and an actuator generating a pressure fluctuation in liquid in the pressure chamber, and is capable of ejecting the liquid from the nozzle by an operation of the actuator; and
a wiper that wipes a nozzle surface of the liquid ejecting head on which the nozzle is formed,
wherein the liquid ejecting apparatus is able to perform a maintenance process by driving the actuator with a driving waveform, and
wherein the maintenance process is performed by driving the actuator with the driving waveform within 3.5 [s] after the nozzle surface is wiped by the wiper so as to perform an ejecting operation.

2. The liquid ejecting apparatus according to claim 1,
wherein the driving waveform is a driving waveform that does not actively draw a meniscus in the nozzle to the pressure chamber side from the initial position, and makes the liquid be ejected from the nozzle by extruding the meniscus toward an ejecting side.

3. The liquid ejecting apparatus according to claim 1,
wherein the driving waveform is a driving waveform that changes the meniscus in the nozzle from the initial position to the pressure chamber side, and makes the liquid be ejected from the nozzle by extruding the meniscus toward an ejecting side.

4. A control method of a liquid ejecting head which includes a pressure chamber communicating with a nozzle and an actuator generating a pressure fluctuation in liquid in the pressure chamber, and is capable of ejecting the liquid from the nozzle by an operation of the actuator, the method comprising:
performing a maintenance process by driving the actuator with the driving waveform within 3.5 [s] after wiping a nozzle surface by a wiper so as to perform an ejecting operation.

5. A control method of a liquid ejecting apparatus which includes a liquid ejecting head that includes a pressure chamber communicating with a nozzle and an actuator generating a pressure fluctuation in liquid in the pressure chamber, and is capable of ejecting the liquid from the nozzle by an operation of the actuator, and a wiper that wipes a nozzle surface on which the nozzle of the liquid ejecting head is formed, and is able to perform a maintenance process by driving the actuator with a driving waveform, the method comprising:
performing the maintenance process by driving the actuator with the driving waveform within 3.5 [s] after wiping the nozzle surface by the wiper so as to perform an ejecting operation.
